(19) United States
(12) Patent Application Publication
(10) Pub. No.: US 2026/0228841 A1
(43) Pub. Date: Aug. 6, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventor: Minami YOSHIDA, Tokyo (JP)

(73) Assignee: NEC Corporation, Tokyo (JP)

(21) Appl. No.: 19/445,741

(22) Filed: Jan. 12, 2026

(30) Foreign Application Priority Data
Feb. 6, 2025 (JP) 2025-018641
Jul. 31, 2025 (JP) 2025-128452

(51) Int. Cl. G06Q 50/18

(52) U.S. Cl. CPC G06Q 50/184

(57) ABSTRACT

An information processing apparatus that creates a claim in a filing document using a generative model includes a first proposal creation unit for referring to an idea of an invention and creating a first proposal of the claim, a generation unit for generating a variation idea related to the first proposal, a determination unit for determining whether the variation idea is an internal addition or an external addition, and a second proposal creation unit for referring to a determination result and creating a second proposal of the claim.

### INCORPORATION BY REFERENCE

This application is based upon and claims the benefit of priority from Japanese patent application No. 2025-018641, filed on February 6, 2025 and Japanese patent application No.2025-128452, filed on July 31, 2025, the disclosure of which is incorporated herein in its entirety by reference.

### TECHNICAL FIELD

The present disclosure relates to an information processing apparatus, an information processing method, and an information processing program.

### BACKGROUND ART

Techniques for creating claims in filing documents using a generative model have been known. For example, WO 2020/240872 A1 discloses a patent sentence generation device that generates a sentence associated with a new claim, based on a training result obtained by training a correspondence between claims of a patent document, documents other than the claims, and a related art document associated with the patent document, and the new claim.

### SUMMARY

In the patent sentence generation device described in WO 2020/240872 A1, how to appropriately cope with a variation idea is not considered. For example, whether the variation idea is expressed as an independent claim or as a dependent claim is not considered in the patent sentence generation device described in WO 2020/240872 A1. Therefore, the patent sentence generation device described in WO 2020/240872 A1 has a problem that it is not possible to efficiently create claims.

The present disclosure has been made in view of the above, and an example object of the present disclosure is to provide a technique for efficiently creating a claim using a generative model.

An information processing apparatus according to one example aspect of the present disclosure that creates a claim in a filing document using a generative model and includes first proposal creation means for referring to an idea of an invention and creating a first proposal of the claim regarding the idea, generation means for generating a variation idea related to the first proposal, determination means for determining whether the variation idea is an internal addition to the first proposal or an external addition to the first proposal, and second proposal creation means for referring to a determination result by the determination means and creating a second proposal of the claim.

An information processing method according to one example aspect of the present disclosure for creating a claim in a filing document using a generative model includes first proposal creation processing for referring to an idea of an invention and creating a first proposal of the claim regarding the idea, by at least one processor, generation processing for generating a variation idea related to the first proposal, by the at least one processor, determination processing for determining whether the variation idea is an internal addition to the first proposal or an external addition to the first proposal, by the at least one processor, and second proposal creation processing for referring to a determination result by the determination processing and creating a second proposal of the claim, by the at least one processor.

An information processing program according to one example aspect of the present disclosure is a program that causes a computer to function as an information processing apparatus that creates a claim in a filing document using a generative model, the information processing program causes the computer to function as first proposal creation means for referring to an idea of an invention and creating a first proposal of the claim regarding the idea, generation means for generating a variation idea related to the first proposal, determination means for determining whether the variation idea is an internal addition to the first proposal or an external addition to the first proposal, and second proposal creation means for referring to a determination result by the determination means and creating a second proposal of the claim.

According to one example aspect of the present disclosure, an exemplary effect is obtained that can provide a technique for efficiently creating a claim using a generative model.

### BRIEF DESCRIPTION OF THE DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating the configuration of the information processing apparatus according to the present disclosure;

FIG. 4 is a flowchart illustrating the flow of the information processing method according to the present disclosure;

FIG. 5 is a diagram illustrating an example of a table output by an output unit according to the present disclosure;

FIG. 6 is a diagram illustrating another example of the table output by the output unit according to the present disclosure;

FIG. 7 is a block diagram illustrating the configuration of the information processing apparatus according to the present disclosure;

FIG. 8 is a flowchart illustrating the flow of the information processing method according to the present disclosure; and

FIG. 9 is a block diagram illustrating a configuration of a computer that functions as the information processing apparatus according to the present disclosure.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extension of the present invention. That is, example embodiments that do not provide the effects mentioned in each of the exemplary example embodiments described below can also be included in the scope of the present invention.

### First Exemplary Example Embodiment

A first exemplary example embodiment that is an example of example embodiments of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment can also be adopted in another exemplary example embodiment included in the present disclosure within a range in which no particular technical problem occurs.

### Configuration of Information Processing Apparatus 1

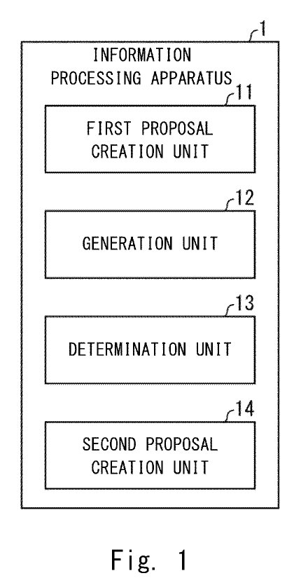

An information processing apparatus 1 is an apparatus that creates a claim in a filing document using a generative model. A configuration of the information processing apparatus 1 will be described with reference to FIG. 1. FIG. 1 is a block diagram illustrating the configuration of the information processing apparatus 1. As illustrated in FIG. 1, the information processing apparatus 1 includes a first proposal creation unit 11, a generation unit 12, a determination unit 13, and a second proposal creation unit 14. The first proposal creation unit 11, the generation unit 12, the determination unit 13, and the second proposal creation unit 14 respectively achieve first proposal creation means, generation means, determination means, and second proposal creation means, in the present exemplary example embodiment.

### First Proposal Creation Unit 11

The first proposal creation unit 11 refers to an idea of an invention and creates a first proposal of a claim regarding the idea, using the generative model. The first proposal creation unit 11 supplies the created first proposal to the generation unit 12 and the determination unit 13.

The first proposal of the claim is a claim generated by the generative model from the idea of the invention and is a claim expressing the idea of the invention. The first proposal of the claim can be expressed as a provisional proposal of the claim. The first proposal may be an independent claim, or may include an independent claim and a dependent claim dependent on the independent claim.

### Generation Unit 12

The generation unit 12 generates a variation idea related to the first proposal, using the generative model. The generation unit 12 supplies the generated variation idea to the determination unit 13 and the second proposal creation unit 14.

The variation idea related to the first proposal is an idea obtained by modifying at least one of the matters specifying the invention included in the first proposal or an idea to be added to the invention expressed by the first proposal and is an idea related to the matters specifying the invention included in the first proposal.

### Determination Unit 13

The determination unit 13 determines whether the variation idea is an internal addition to the first proposal or an external addition to the first proposal, using the generative model. The determination unit 13 supplies a determination result to the second proposal creation unit 14.

The fact that the variation idea is the internal addition to the first proposal indicates any one of (1) the variation idea is an idea that limits at least one of the matters specifying the invention included in the first proposal, (2) the variation idea is a detailed idea of at least one of the matters specifying the invention included in the first proposal, and (3), the variation idea is an idea to be added in parallel to the matters specifying the invention included in the first proposal.

As an example, in a case where the variation idea is “infrared communication using near infrared rays” that limits “infrared communication” included in the first proposal, the variation idea is the internal addition to the first proposal. As another example, in a case where the variation idea is “visible light communication” to be added in parallel to “infrared communication” included in the first proposal, the variation idea is the internal addition to the first proposal.

The fact that the variation idea is the external addition to the first proposal indicates that the variation idea is a new matter specifying the invention different from the matters specifying the invention included in the first proposal. As an example, in a case where the first proposal is an image processing device including acquisition means for acquiring an image and image processing means for executing image processing on the acquired image and the variation idea is output means for outputting the image-processed image, the variation idea is the external addition to the first proposal.

### Second Proposal Creation Unit 14

The second proposal creation unit 14 refers to the determination result by the determination unit 13 and creates a second proposal of the claim, using the generative model.

The second proposal of the claim is a claim including a configuration of the variation idea with respect to the first proposal. The second proposal may be created by making addition to or modifying the first proposal or created independently of the first proposal.

### Effects of Information Processing Apparatus 1

As described above, the information processing apparatus 1 is an apparatus that creates the claims in the filing document using the generative model and adopts a configuration including the first proposal creation unit 11 that refers to the idea of the invention and creates the first proposal of the claim regarding the idea, the generation unit 12 that generates the variation idea related to the first proposal, the determination unit 13 that determines whether the variation idea is the internal addition to the first proposal or the external addition to the first proposal, and the second proposal creation unit 14 that refers to the determination result by the determination unit 13 and creates the second proposal of the claim.

Therefore, according to the information processing apparatus 1, an effect is obtained that the claims can be efficiently created using the generative model.

### Flow of Information Processing Method S1

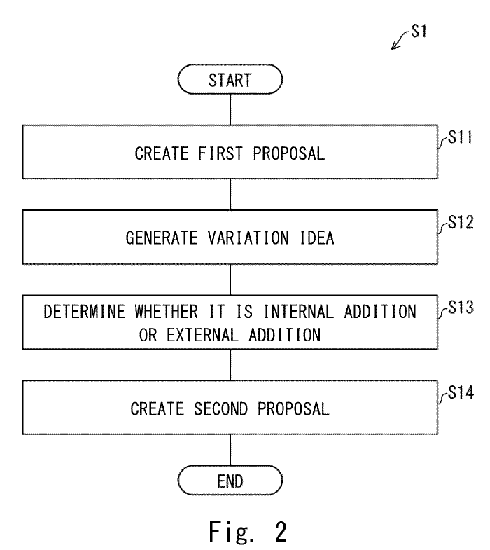

A flow of an information processing method S1 will be described with reference to FIG. 2. FIG. 2 is a flowchart illustrating the flow of the information processing method S1. As illustrated in FIG. 2, the information processing method S1 includes first proposal creation processing S11, generation processing S12, determination processing S13, and second proposal creation processing S14.

### First Proposal Creation Processing S11

In the first proposal creation processing S11, the first proposal creation unit 11 refers to the idea of the invention and creates the first proposal of the claim regarding the idea, using the generative model. The first proposal creation unit 11 supplies the created first proposal to the generation unit 12 and the determination unit 13.

### Generation Processing S12

In the generation processing S12, the generation unit 12 generates the variation idea related to the first proposal, using the generative model. The generation unit 12 supplies the generated variation idea to the determination unit 13 and the second proposal creation unit 14.

### Determination Processing S13

In the determination processing S13, the determination unit 13 determines whether the variation idea is the internal addition to the first proposal or the external addition to the first proposal, using the generative model. The determination unit 13 supplies the determination result to the second proposal creation unit 14.

### Second Proposal Creation Processing S14

In the second proposal creation processing S14, the second proposal creation unit 14 refers to the determination result by the determination unit 13 and creates the second proposal of the claim, using the generative model.

### Effects of Information Processing Method S1

As described above, in the information processing method S1, a configuration is adopted including the first proposal creation processing S11 in which the first proposal creation unit 11 refers to the idea of the invention and creates the first proposal of the claim regarding the idea, the generation processing S12 in which the generation unit 12 generates the variation idea related to the first proposal, the determination processing S13 in which the determination unit 13 determines whether the variation idea is the internal addition to the first proposal or the external addition to the first proposal, and the second proposal creation processing S14 in which the second proposal creation unit 14 refers to the determination result by the determination unit 13 and creates the second proposal of the claim. Therefore, according to the information processing method S1, an effect similar to that of the information processing apparatus 1 described above may be obtained.

### Second Exemplary Example Embodiment

A second exemplary example embodiment that is an example of example embodiments of the present invention will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within the scope in which no particular technical problem occurs.

### Outline of information Processing Apparatus 2

An information processing apparatus 2 is an apparatus that creates a claim in a filing document using a generative model GM. As an example of the claim created by the information processing apparatus 2, claims in patent filing documents and claims in utility model filing documents are exemplified.

More specifically, the information processing apparatus 2 creates a first proposal D1 of a claim expressing an idea of an invention, using the generative model GM. A data format of the idea of the invention is not limited, and for example, a text, an image, and voice are exemplified. The idea of the invention expresses a patentable invention, and includes problems and solution means of the invention.

The generative model GM is a model trained to generate new content. Examples of the generative model GM include Bidirectional Encoder Representations from Transformers (BERT), a Generative Pre-trained Transformer (GPT), and Large Language Models (LLM) such as cotomi.

The information processing apparatus 2 generates a variation idea VI related to the first proposal D1, refers to a determination result indicating whether the variation idea VI is an internal addition to the first proposal D1 or an external addition to the first proposal D1, and creates a second proposal D2.

As an example of the configuration in which the information processing apparatus 2 refers to the determination result indicating whether the variation idea is the internal addition to the first proposal D1 or the external addition to the first proposal D1 and creates the second proposal D2, in a case where the variation idea is determined as the internal addition to the first proposal D1, the information processing apparatus 2 creates the second proposal D2 obtained by adding a superordinate concept of the variation idea to the first proposal D1.

As another example of the configuration in which the information processing apparatus 2 refers to the determination result indicating whether the variation idea is the internal addition to the first proposal D1 or the external addition to the first proposal D1 and creates the second proposal D2, in a case where the variation idea is determined as the external addition to the first proposal D1, the information processing apparatus 2 creates the second proposal D2 by changing the variation idea into a dependent claim and adding the dependent claim to the first proposal D1. Changing the variation idea into the dependent claim indicates causing the claim expressing the variation idea to be dependent on another claim. The dependent claim includes all limitations of the referenced claim and adds additional limitations.

The information processing apparatus 2 creates a patent specification, with the second proposal D2 as a claim. The information processing apparatus 2 may submit the generated patent specification or the like to a server of a receiving office and file an application. Alternatively, the information processing apparatus 2 may automatically execute filing processing, in cooperation with a filing terminal for executing filing.

### Configuration of Information Processing Apparatus 2

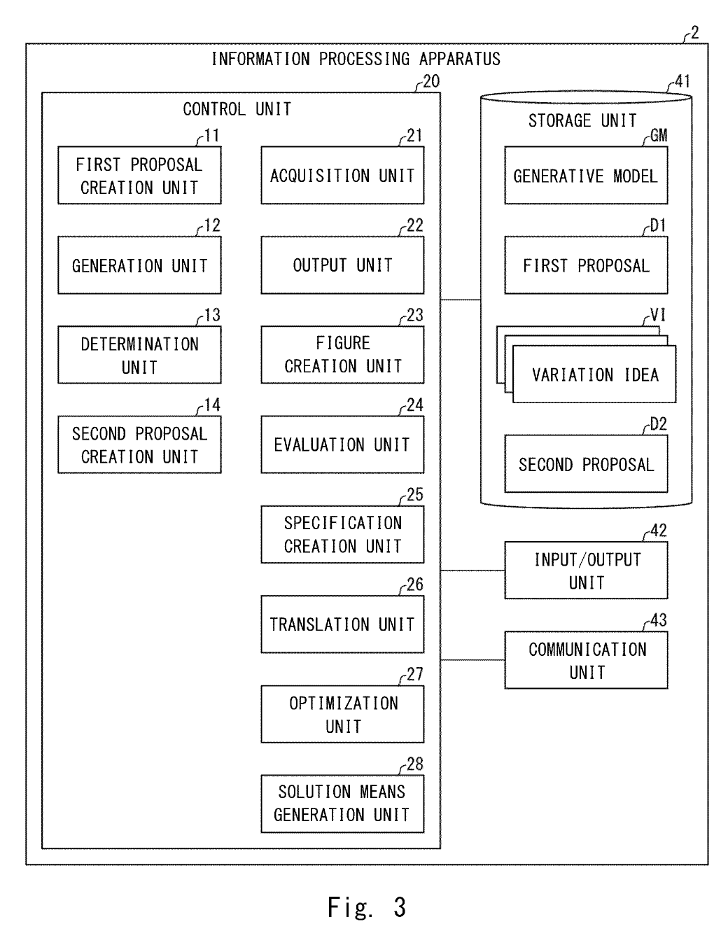

A configuration of the information processing apparatus 2 will be described with reference to FIG. 3. FIG. 3 is a block diagram illustrating the configuration of the information processing apparatus 2. As illustrated in FIG. 3, the information processing apparatus 2 includes a control unit 20, a storage unit 41, an input/output unit 42, and a communication unit 43.

### Storage Unit 41

The storage unit 41 stores data referred by the control unit 20. Examples of the storage unit 41 include, but are not limited to, a flash memory, a Hard Disk Drive (HDD), a Solid State Drive (SSD), and a combination thereof. Examples of the data stored in the storage unit 41 include the generation model GM, the first proposal D1, the one or the plurality of variation ideas VI, and the second proposal D2 as illustrated in FIG. 3.

### Input/Output Unit 42

The input/output unit 42 is an interface with an input device that receives a data input and an output device that outputs data. Examples of the input device include, but are not limited to, a microphone, a camera, a line-of-sight input device, a keyboard, and a touch pad. Examples of the output device include, but are not limited to, a speaker and a liquid crystal display. The input/output unit 42 may be the input device or the output device.

### Communication Unit 43

The communication unit 43 is an interface for exchanging data via a network. Examples of the communication unit 43 include, but are not limited to, communication chips in various communication standards such as Ethernet (registered trademark), Wi-Fi (registered trademark), and wireless communication standards of mobile data communication networks, and connectors compliant with USB. As an example, the communication unit 43 exchanges data with the server of the receiving office.

### Control Unit 20

The control unit 20 controls each component included in the information processing apparatus 2. As illustrated in FIG. 3, the control unit 20 includes a first proposal creation unit 11, a generation unit 12, a determination unit 13, a second proposal creation unit 14, an acquisition unit 21, an output unit 22, a figure creation unit 23, an evaluation unit 24, a specification creation unit 25, a translation unit 26, an optimization unit 27, and a solution means generation unit 28. The first proposal creation unit 11, the generation unit 12, the determination unit 13, the second proposal creation unit 14, the acquisition unit 21, the output unit 22, the figure creation unit 23, the evaluation unit 24, the specification creation unit 25, the translation unit 26, the optimization unit 27, and the solution means generation unit 28 respectively achieve first proposal creation means, generation means, determination means, second proposal creation means, acquisition means, output means, figure creation means, evaluation means, specification creation means, translation means, optimization means, and solution means generation means, in the present exemplary example embodiment.

### First Proposal Creation Unit 11

The first proposal creation unit 11 refers to the idea of the invention and creates the first proposal D1 of the claim regarding the idea. More specifically, the first proposal creation unit 11 creates the first proposal D1, by inputting information indicating the idea of the invention and a prompt for instructing to create a claim into the generative model GM. Here, examples of the information indicating the idea of the invention include a problem to be solved by the idea of the invention, solution means of the problem, information indicating a claim proposal regarding the idea of the invention, or the like, but not limited thereto.

As an example, the first proposal creation unit 11 inputs a text describing the problems and the solution means of the invention and the following prompt into the generative model GM. The prompt may include a text describing the claim proposal regarding the idea of the invention.

Please create a claim expressing an idea of an invention, based on problems and solution means of the invention.

The first proposal creation unit 11 stores the created first proposal D1 in the storage unit 41.

### Generation Unit 12

The generation unit 12 generates the variation idea VI related to the first proposal D1. More specifically, the generation unit 12 generates the variation idea VI, by inputting the first proposal D1 and a prompt instructing to generate the variation idea VI into the generative model GM.

As an example, the generation unit 12 inputs the first proposal D1 and the following prompt into the generative model GM.

Please generate a variation idea of the matters specifying the invention included in a first proposal.

The generation unit 12 stores the generated variation idea VI in the storage unit 41.

The generation unit 12 may generate the plurality of variation ideas VI. As an example of the configuration, the generation unit 12 inputs the first proposal D1 and the following prompt into the generative model GM.

Please generate the plurality of variation ideas of the matters specifying the invention included in the first proposal.

The generation unit 12 may generate a variation idea VI derived from the variation idea VI. As an example, the generation unit 12 generates the variation idea derived from the variation idea VI selected from among the plurality of variation ideas VI. More specifically, the generation unit 12 generates the variation idea derived from the selected variation idea VI, by inputting the selected variation idea VI and a prompt for instructing to generate the variation idea derived from the variation idea VI into the generative model GM. Here, the derived variation idea indicates a new idea obtained by further developing the selected variation idea VI. The new idea is an idea further detailed, embodied, or expanded based on the original variation idea and presents new aspects and possibilities while maintaining relevance with the original variation idea.

As an example, the generation unit 12 inputs the selected variation idea VI and the following prompt into the generative model GM.

Please generate a variation idea derived from the variation idea.

With this configuration, since the generation unit 12 can generate the variation idea VI derived from the variation idea VI selected from among the plurality of variation ideas VI by a user, it is possible to generate the variation idea VI along user’s intention.

The generation unit 12 may generate a variation idea VI specialized in a field related to the invention. Examples of the field related to the invention include a technical field to which the invention belongs and a field to which the invention can be applied. For example, the generation unit 12 generates the variation idea VI specialized in the field related to the invention, by inputting the first proposal D1 and a prompt for instructing to generate the variation idea VI specialized in the field related to the invention regarding the first proposal D1 into the generative model GM. Here, the variation idea VI specialized in the field related to the invention indicates a modified or extended idea derived by focusing on a specific technical field or application, based on the idea of the invention regarding the first proposal D1. The variation idea VI specialized in the field related to the invention is generated for the purpose of solving problems and improving performance in a specific field, while maintaining basic concept of the original invention. For example, in a case of an invention related to data processing, a data processing method specialized in a medical field, a data analysis algorithm specialized in a financial field, and the like are considered as the specialized variation ideas VI.

As an example, the generation unit 12 inputs the first proposal D1 and the following prompt into the generative model GM.

-Please generate a variation idea specialized in a field related to the invention regarding the first proposal.

With this configuration, the generation unit 12 can generate the variation idea VI suitable for the invention.

The generation unit 12 may generate a variation idea VI based on a patent strategy. The patent strategy is a strategy for utilizing the patent such as acquisition of the patent or exercise of patent rights. Based on the patent strategy refers to analyzing a patent strategy of an applicant company or a patent strategy of another company and based on an analysis result, in a case where the applicant is the company. For example, the generation unit 12 generates the variation idea VI based on the patent strategy, by inputting the first proposal D1 and a prompt for instructing to generate the variation idea VI based on the patent strategy into the generative model GM.

As an example, the generation unit 12 inputs the first proposal D1 and the following prompt into the generative model GM.

-Please generate a variation idea of the matters specifying the invention included in the first proposal, based on analysis results of our company’s (or other company’s) patent strategy.

With this configuration, the generation unit 12 can generate the variation idea VI according to the patent strategy of the applicant company or the patent strategy of the other company.

The generation unit 12 may refer to information regarding a patent similar to the invention or a patent in the technical field related to the invention and generate the variation idea VI. As an example, the generation unit 12 refers to the information regarding the patent similar to the invention or the patent in the technical field related to the invention, using a past patent database. For example, the generation unit 12 refers to the first proposal D1 and the information regarding the patent similar to the invention or the patent in the technical field related to the invention and generates the variation idea VI by inputting the prompt for instructing to generate the variation idea VI into the generative model GM.

As an example, the generation unit 12 inputs the first proposal D1 and the following prompt into the generative model GM.

-Please generate the variation idea of the matters specifying the invention included in the first proposal, with reference to a patent database.

With this configuration, the generation unit 12 can generate the variation idea VI based on past patent information.

### Determination Unit 13

The determination unit 13 determines whether the variation idea VI is the internal addition to the first proposal D1 or the external addition to the first proposal D1. More specifically, the determination unit 13 determines whether the variation idea VI is the internal addition to the first proposal D1 or the external addition to the first proposal D1, by inputting the first proposal D1, the variation idea VI, and a prompt for instructing to determine whether the variation idea VI is the internal addition to the first proposal D1 or the external addition to the first proposal D1, into the generative model GM. The internal addition and the external addition are as described above.

As an example, the determination unit 13 inputs the first proposal D1, the variation idea VI, and the following prompt into the generative model GM.

Please determine whether the variation idea is an internal addition or an external addition to the first proposal. The internal addition means to limit or detail a part of the matters specifying the invention described in the existing claims. Specifically, a change from a superordinate concept to a subordinate concept and parallel addition of the matters specifying the invention are applicable. With the internal addition, the invention can be more specifically identified within the scope of the original claim. The external addition means to add a new matter specifying the invention, in addition to the matters specifying the invention described in the existing claims. Specifically, adding a new component in series to the components of the original claims is applicable. With the external addition, the scope of the original claims can be extended or changed.

The determination unit 13 supplies the determination result to the second proposal creation unit 14.

### Second Proposal Creation Unit 14

The second proposal creation unit 14 refers to the determination result by the determination unit 13 and creates the second proposal D2 of the claim. More specifically, the second proposal creation unit 14 creates the second proposal D2, by inputting the first proposal D1, the variation idea VI, the determination result, and a prompt for instructing to generate the second proposal D2 into the generative model GM.

As an example, the second proposal creation unit 14 inputs the first proposal D1, the variation idea VI, the determination result, and the following prompt into the generative model GM.

-Please create a claim including the configuration of the variation idea, based on the first proposal and the determination result.

The second proposal creation unit 14 stores the created second proposal D2 in the storage unit 41.

The second proposal creation unit 14 may create the second proposal D2 by a predetermined method according to the determination result. More specifically, in a case where it is determined that the variation idea VI is the internal addition to the first proposal D1, the second proposal creation unit 14 creates the second proposal D2 obtained by adding the superordinate concept of the variation idea VI to the first proposal D1. In a case where it is determined that the variation idea VI is the external addition to the first proposal D1, the second proposal creation unit 14 creates the second proposal D2 in which the variation idea VI is changed into a dependent claim and added to the first proposal D1.

As an example, the second proposal creation unit 14 inputs the first proposal D1, the variation idea VI, the determination result, and the following prompt into the generative model GM.

-In a case where the determination result is the internal addition, please create a claim by adding a superordinate concept of the variation idea to the first proposal. In a case where the determination result is the external addition, please create a claim in which the variation idea is changed into the dependent claim and added to the first proposal.

With this configuration, the second proposal creation unit 14 can appropriately create a claim including the variation idea, according to whether the variation idea is the internal addition or the external addition.

The determination result referred by the second proposal creation unit 14 may be a determination result input by the user. In this case, the second proposal creation unit 14 creates the second proposal D2 of the claim according to the input from the user.

With this configuration, the second proposal creation unit 14 can appropriately create the claim including the variation idea, after confirming whether the determination result by the determination unit 13 is appropriate, to the user.

In a case of receiving an input indicating agreement with the determination result, the second proposal creation unit 14 may refer to the determination result and create the second proposal D2 of the claim. In other words, in a case where the user determines that the determination result is correct, the second proposal creation unit 14 may create the second proposal D2 based on the determination result.

With this configuration, since the second proposal creation unit 14 creates the second proposal D2 after causing the user to confirm that the determination result is correct, the second proposal creation unit 14 can more appropriately create the claim including the variation idea.

The second proposal creation unit 14 may create the plurality of second proposals D2. As an example of the configuration, the second proposal creation unit 14 inputs the first proposal D1, the variation idea VI, the determination result, and the following prompt into the generative model GM.

Please create a plurality of claims including the configuration of the variation idea based on the first proposal and the determination result.

The second proposal creation unit 14 may create the second proposal D2 based on user’s desire. As an example, the second proposal creation unit 14 modifies the second proposal D2, based on desire to modify the second proposal D2.

With this configuration, the second proposal creation unit 14 can create the second proposal D2 along the user’s desire.

### Acquisition Unit 21

The acquisition unit 21 acquires data via the input/output unit 42 or the communication unit 43. The acquisition unit 21 stores the acquired data in the storage unit 41. As an example, the acquisition unit 21 acquires an input from the user. As another example, the acquisition unit 21 acquires information indicating the idea of the invention. As still another example, the acquisition unit 21 acquires the problem of the invention.

Examples of the input of the user acquired by the acquisition unit 21 include an input for a determination result output by the output unit 22 to be described later is exemplified.

As another example of the input of the user acquired by the acquisition unit 21, an input indicating that the user has selected at least any one of the plurality of second proposals D2 output by the output unit 22 to be described later is exemplified.

With this configuration, the acquisition unit 21 can specify the second proposal D2 selected by the user, from among the plurality of second proposals D2.

As still another example of the input of the user acquired by the acquisition unit 21, an input indicating that the user has selected at least any one of the plurality of variation ideas VI output by the output unit 22 to be described later is exemplified.

As yet another example of the input of the user acquired by the acquisition unit 21, an input indicating whether to agree with the determination result output by the output unit 22 to be described later is exemplified.

As still yet another example of the input of the user acquired by the acquisition unit 21, an input regarding the user’s desire with respect to the second proposal D2 output by the output unit 22 to be described later is exemplified.

### Output Unit 22

The output unit 22 outputs data via the input/output unit 42 or the communication unit 43. As an example, the output unit 22 outputs the determination result by the determination unit 13. As another example, the output unit 22 outputs the variation idea VI and an evaluation result evaluated by the evaluation unit 24 to be described later. As still another example, the output unit 22 outputs the plurality of second proposals D2. As yet another example, the output unit 22 outputs the plurality of variation ideas VI. As still yet another example, the output unit 22 outputs the filing document to the server of the receiving office.

### Figure Creation Unit 23

The figure creation unit 23 creates a drawing regarding the second proposal D2. More specifically, the figure creation unit 23 generates the drawing, by inputting the second proposal D2 and a prompt for instructing to create the drawing into the generative model GM. Although the drawing is not particularly limited, and as an example, a block diagram or a conceptual diagram illustrating the configuration of the invention is exemplified.

As an example, the generation unit 12 inputs the second proposal D2 and the following prompt into the generative model GM.

Please create a block diagram or a conceptual diagram of the invention regarding the claim.

The figure creation unit 23 stores the created drawing in the storage unit 41.

With this configuration, the figure creation unit 23 can suitably create the drawings in the filing document with the second proposal D2 as the claim.

### Evaluation Unit 24

The evaluation unit 24 evaluates feasibility and ease of infringement confirmation of the variation idea VI. More specifically, the evaluation unit 24 evaluates the feasibility and the ease of infringement confirmation of the variation idea VI, by inputting the variation idea VI and a prompt for instructing to evaluate the feasibility and the ease of infringement confirmation into the generative model GM. The feasibility is an index indicating a degree at which the variation idea VI can be technically achieved. The feasibility is evaluated, for example, in three stages of high, medium, and low, but is not limited thereto. The ease of infringement confirmation is an index indicating ease of confirming whether the patent right including the variation idea VI is infringed. The ease of infringement confirmation is evaluated, for example, in three stages of easy, normal, and difficult, but not limited thereto.

As an example, the evaluation unit 24 inputs the variation idea VI and the following prompt into the generative model GM.

Please evaluate feasibility and ease of infringement confirmation of the variation idea VI.

The evaluation unit 24 stores evaluation results of the feasibility and the ease of infringement confirmation in the storage unit 41.

The evaluation unit 24 may rank the feasibility and the ease of infringement confirmation, for the plurality of variation ideas VI.

As described above, the output unit 22 outputs the evaluated feasibility and ease of infringement confirmation. With this configuration, the evaluation unit 24 can present the feasibility and the ease of infringement confirmation of the variation idea VI to the user.

The evaluation unit 24 may evaluate patentability of the second proposal D2, in addition or instead of the configuration described above. Examples of the patentability evaluated by the evaluation unit 24 include novelty and inventive step. More specifically, the evaluation unit 24 evaluates the patentability of the second proposal D2, by inputting the second proposal D2 and a prompt for instructing to evaluate the patentability into the generative model GM.

As an example, the evaluation unit 24 inputs the second proposal D2 and the following prompt into the generative model GM.

Please evaluate novelty and an inventive step of a second proposal.

The evaluation unit 24 stores an evaluation result of the patentability in the storage unit 41.

With this configuration, the evaluation unit 24 can suitably evaluate the patentability of the created second proposal D2.

### Specification Creation Unit 25

The specification creation unit 25 creates the patent specification, with the second proposal D2 as the claim. More specifically, the specification creation unit 25 creates the patent specification with the second proposal D2 as the claim, by inputting the second proposal D2 and a prompt for instructing to create the patent specification into the generative model GM.

As an example, the specification creation unit 25 inputs the second proposal D2 and the following prompt into the generative model GM.

Please create a patent specification with the second proposal as a claim.

The specification creation unit 25 stores the created patent specification in the storage unit 41.

With this configuration, the specification creation unit 25 can suitably create the patent specification with the second proposal D2 as the claim.

### Translation Unit 26

The translation unit 26 translates the second proposal D2 into a single or a plurality of languages. More specifically, the translation unit 26 translates the second proposal D2 into the single or the plurality of languages, by inputting the second proposal D2 and a prompt for instructing to translate into the single or the plurality of languages into the generative model GM. The translation unit 26 may translate the patent specification created by the specification creation unit 25 into another language, in addition or instead of the second proposal D2.

As an example, the translation unit 26 inputs the second proposal D2 and the following prompt into the generative model GM.

Please translate the second proposal into English.

The translation unit 26 stores the translated second proposal D2 in the storage unit 41.

With this configuration, the translation unit 26 can suitably translate the second proposal D2 into another language.

### Optimization Unit 27

The optimization unit 27 refers to technical terms in the field of the invention and optimizes the second proposal D2. More specifically, the optimization unit 27 optimizes the second proposal D2, by inputting the second proposal D2 and a prompt for instructing to optimize the second proposal D2 with reference to the technical terms in the field of the invention into the generative model GM. Here, the optimization includes, for example, changing the expression of the second proposal D2 to an expression using the technical terms in the field of the invention. As an example of the method for referring to the technical term in the field of the invention, a method for referring to a database of dictionaries describing the technical terms in the field of the invention is exemplified.

As an example, the optimization unit 27 inputs the second proposal D2 and the following prompt into the generative model GM.

-Please refer to a dictionary describing technical terms in the field of the invention of the second proposal and optimize the second proposal.

The optimization unit 27 stores the optimized second proposal D2 in the storage unit 41.

With this configuration, the optimization unit 27 can suitably optimize the description of the second proposal D2.

### Solution Means Generation Unit 28

The solution means generation unit 28 generates solution means for solving problems. More specifically, the solution means generation unit 28 generates the solution means, by inputting the problem acquired by the acquisition unit 21 and a prompt for instructing to generate the solution means that solves the problem into the generative model GM.

As an example, the solution means generation unit 28 inputs the problem acquired by the acquisition unit 21 and the following prompt into the generative model GM.

Please create the solution means for solving the problem.

The solution means generation unit 28 stores the generated solution means in the storage unit 41.

With this configuration, for example, the solution means generation unit 28 can cause the user to perform training for deriving solution means for virtual problems.

### Example of Flow of Processing Executed by Information Processing Apparatus 2

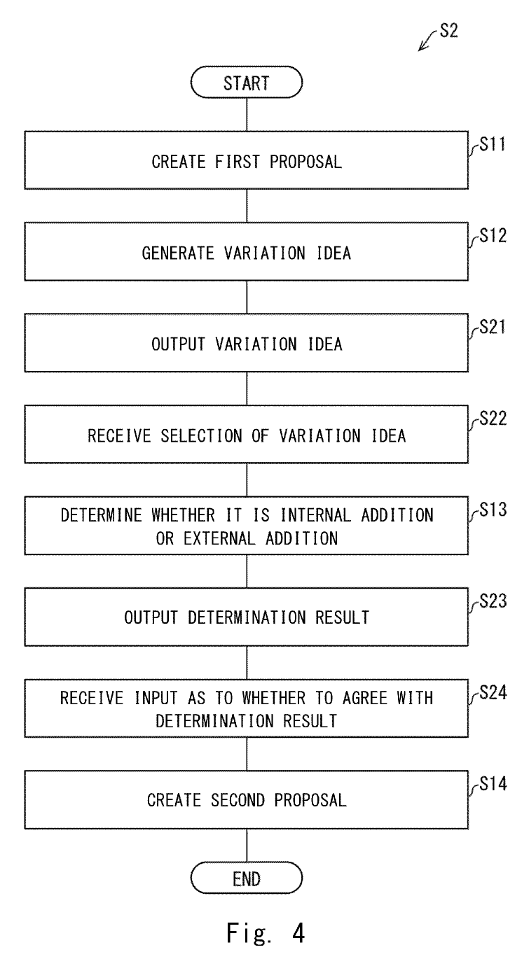

An example of a flow of processing (information processing method S2) executed by the information processing apparatus 2 will be described with reference to FIG. 4. FIG. 4 is a flowchart illustrating an example of the flow of the information processing method S2.

(Step S11)

In step S11, the first proposal creation unit 11 creates the first proposal D1, by inputting the information indicating the idea of the invention and the prompt for instructing to create the claim into the generative model GM. The first proposal creation unit 11 stores the created first proposal D1 in the storage unit 41.

### Step S12

In step S12, the generation unit 12 generates the single or the plurality of variation ideas VI, by inputting the first proposal D1 and the prompt for instructing to generate the single or the plurality of variation ideas VI into the generative model GM. The generation unit 12 stores the generated variation idea VI in the storage unit 41.

### Step S21

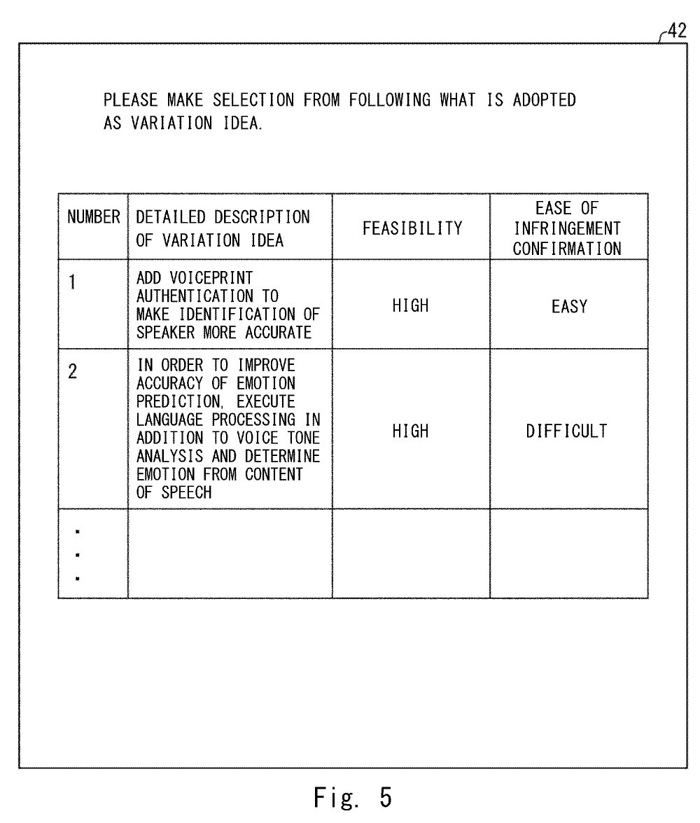

In step S21, the output unit 22 outputs the variation idea VI generated in step S12. An example of a table output in this case will be described with reference to FIG. 5. FIG. 5 is a diagram illustrating an example of the table output by the output unit 22.

In step S21, as illustrated in FIG. 5, as an example, the output unit 22 outputs a table including the plurality of generated variation ideas VI. Before execution of step S21, the evaluation unit 24 may evaluate the feasibility and the ease of infringement confirmation of each of the plurality of variation ideas VI. In this case, as illustrated in FIG. 5, the output unit 22 outputs a table in which each of the plurality of variation ideas VI and the evaluated feasibility and ease of infringement confirmation are associated.

Instead of or in addition to the processing for evaluating the feasibility and the ease of infringement confirmation by the evaluation unit 24, before the execution of step S21, the determination unit 13 may determine whether each of the plurality of variation ideas VI is the internal addition to the first proposal D1 or the external addition to the first proposal D1. In this case, the output unit 22 outputs the table in which each of the plurality of variation ideas VI and the determination result indicating whether the variation idea VI is the internal addition to the first proposal D1 or the external addition to the first proposal D1 are associated.

For example, in a case where the evaluation unit 24 evaluates the feasibility and the ease of infringement confirmation for each of the plurality of variation ideas VI before the execution of step S21 and the determination unit 13 determines whether the variation idea VI is the internal addition to the first proposal D1 or the external addition to the first proposal D1, the output unit 22 outputs a table in which each of the plurality of variation ideas VI, the evaluated feasibility and ease of infringement confirmation, and the determination result indicating whether the variation idea VI is the internal addition to the first proposal D1 or the external addition to the first proposal D1 are associated.

### Step S22

In step S22, the acquisition unit 21 receives an input indicating that the user has selected at least any one of the variation ideas VI output in step S21. The acquisition unit 21 supplies the variation idea VI selected by the user to the determination unit 13.

For example, the table illustrated in FIG. 5 described above may include an interface for receiving the input indicating that at least any one of the variation ideas VI has been selected. The acquisition unit 21 acquires the input from the user via the interface, as the input indicating that the user has selected at least any one of the variation ideas VI.

In a case where the output unit 22 outputs the table in which each of the plurality of variation ideas, the evaluated feasibility and ease of infringement confirmation, and the determination result indicating whether the variation idea is the internal addition to the first proposal D1 or the external addition to the first proposal D1 are associated, the user can select at least any one of the plurality of variation ideas, after confirming the feasibility and the ease of infringement confirmation of the plurality of variation ideas VI and whether the variation idea is the internal addition to the first proposal D1 or the external addition to the first proposal D1.

In a case where the output unit 22 outputs the table in which each of the plurality of variation ideas and the determination result indicating whether the variation idea is the internal addition to the first proposal D1 or the external addition to the first proposal D1 are associated, the acquisition unit 21 may further receive an input as to whether to agree with the determination result.

### Step S13

In step S13, the determination unit 13 determines whether the variation idea VI selected in step S22 is the internal addition to the first proposal D1 or the external addition to the first proposal D1, by inputting the variation idea VI selected in step S22, the first proposal D1, and the prompt for instructing to determine whether the variation idea VI is the internal addition to the first proposal D1 or the external addition to the first proposal D1 into the generative model GM. The determination unit 13 supplies the determination result to the output unit 22.

Before execution of step S13, the generation unit 12 may generate the variation idea VI derived from the variation idea VI selected in step S22, by inputting the first proposal D1, the variation idea VI selected in step S22, and the prompt for instructing to generate the variation idea derived from the variation idea VI into the generative model GM.

In a case where the determination unit 13 determines whether each of the plurality of variation ideas VI is the internal addition to the first proposal D1 or the external addition to the first proposal D1 before the execution of step S21, the processing in step S13 may be omitted.

### Step S23

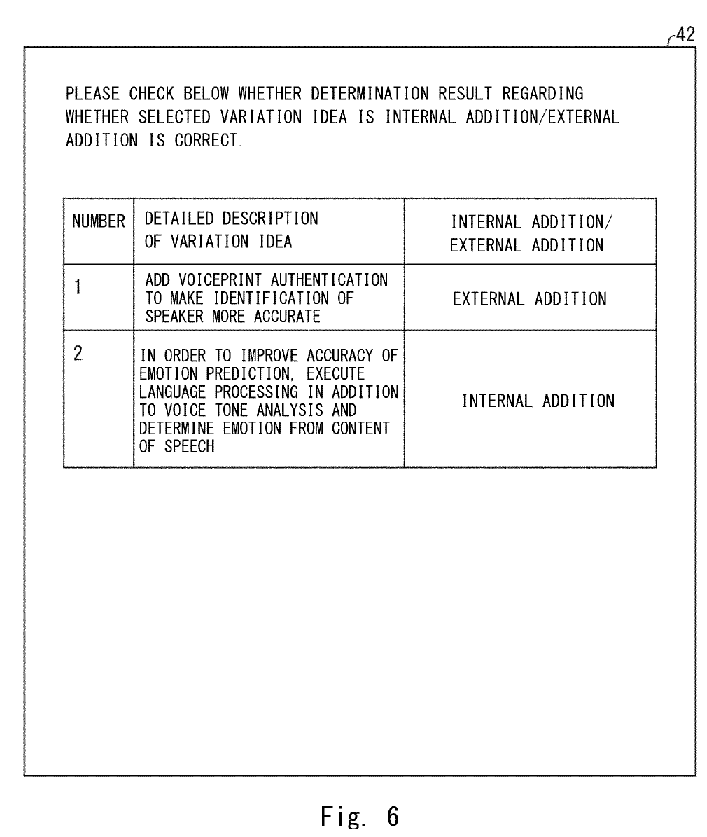

In step S23, the output unit 22 outputs the determination result in step S13. An example of a table output in this case will be described with reference to FIG. 6. FIG. 6 is a diagram illustrating another example of the table output by the output unit 22.

As an example, in a case where the output unit 22 outputs the table illustrated in FIG. 5 in step S21 and numbers 1 and 2 in the table illustrated in FIG. 5 are selected in step S22, the output unit 22 outputs a table in which variation ideas VI with the numbers 1 and 2 to be determined in step S13 and the determination result of the plurality of variation ideas VI are associated, as illustrated in FIG. 6, in step S23.

### Step S24

In step S24, the acquisition unit 21 receives an input as to whether to agree with the determination result. The acquisition unit 21 supplies the received input to the second proposal creation unit 14.

For example, the table illustrated in FIG. 6 described above may include an interface for receiving the input as to whether to agree with the determination result. The acquisition unit 21 acquires the input from the user via the interface as the input as to whether to agree with the determination result. In a case where the determination unit 13 determines whether each of the plurality of variation ideas VI is the internal addition to the first proposal D1 or the external addition to the first proposal D1 before the execution of step S21 and the acquisition unit 21 receives the input as to whether to agree with the determination result in step S22, the processing in steps S23 and S24 may be omitted.

### Step S14

In step S14, the second proposal creation unit 14 creates the second proposal D2 according to the input as to whether to agree with the determination result in step S24. For example, in a case where it is determined that the variation idea VI is the internal addition to the first proposal D1 and the input as to whether to agree with the determination result in step S24 is an input indicating agreement with the determination result, the second proposal creation unit 14 creates the second proposal D2 obtained by adding the superordinate concept of the variation idea VI to the first proposal D1. In a case where it is determined that the variation idea VI is the external addition to the first proposal D1 and the input as to whether to agree with the determination result in step S24 is the input indicating the agreement with the determination result, the second proposal creation unit 14 creates the second proposal D2 in which the variation idea VI is changed into the dependent claim and added to the first proposal D1. On the other hand, in a case where the input as to whether to agree with the determination result in step S24 is an input indicating disagreement with the determination result, step S13 described above may be executed again.

### Processing in and after Step S14

After execution of step S14, the information processing apparatus 2 may execute at least one of the following processing.

The figure creation unit 23 generates the drawing, by inputting the second proposal D2 and the prompt for instructing to create the drawing into the generative model GM.

The evaluation unit 24 evaluates the patentability of the second proposal D2, by inputting the second proposal D2 and the prompt for instructing to evaluate the patentability into the generative model GM.

-The specification creation unit 25 creates the patent specification with the second proposal D2 as the claim, by inputting the second proposal D2 and the prompt for instructing to create the patent specification into the generative model GM.

The translation unit 26 translates the second proposal D2 into the single or the plurality of languages, by inputting the second proposal D2 and the prompt for instructing to translate into the single or the plurality of languages into the generative model GM.

The optimization unit 27 optimizes the second proposal D2, by inputting the second proposal D2 and the prompt for instructing to optimize the second proposal D2 with reference to the technical terms in the field of the invention into the generative model GM.

The acquisition unit 21 acquires the problem, and the solution means generation unit 28 generates the solution means, by inputting the problem acquired by the acquisition unit 21 and the prompt for instructing to generate the solution means that solves the problem into the generative model GM.

The output unit 22 outputs the filing document to the server of the receiving office.

### Effect of Information Processing Apparatus 2

As described above, the information processing apparatus 2 generates the variation idea VI related to the first proposal D1 of the claim regarding the idea of the invention, using the generative model GM. The information processing apparatus 2 refers to the determination result obtained by determining whether the variation idea VI is the internal addition or the external addition to the first proposal D1 and creates the second proposal D2 of the claim.

Therefore, according to the information processing apparatus 2, since it is possible to create a claim proposal according to whether the generated variation idea VI is the internal addition or the external addition, it is possible to efficiently create the claim using the generative model GM.

### Third Exemplary Example Embodiment

A third exemplary example embodiment that is an example of example embodiments of the present invention will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within the scope in which no particular technical problem occurs.

### Outline of Information Processing Apparatus 3

An information processing apparatus 3 is an apparatus that generates solution means for solving a problem. As an example, the information processing apparatus 3 is an apparatus that generates solution means for a virtual problem and performs training for an inventor to derive the solution means.

### Configuration of Information Processing Apparatus 3

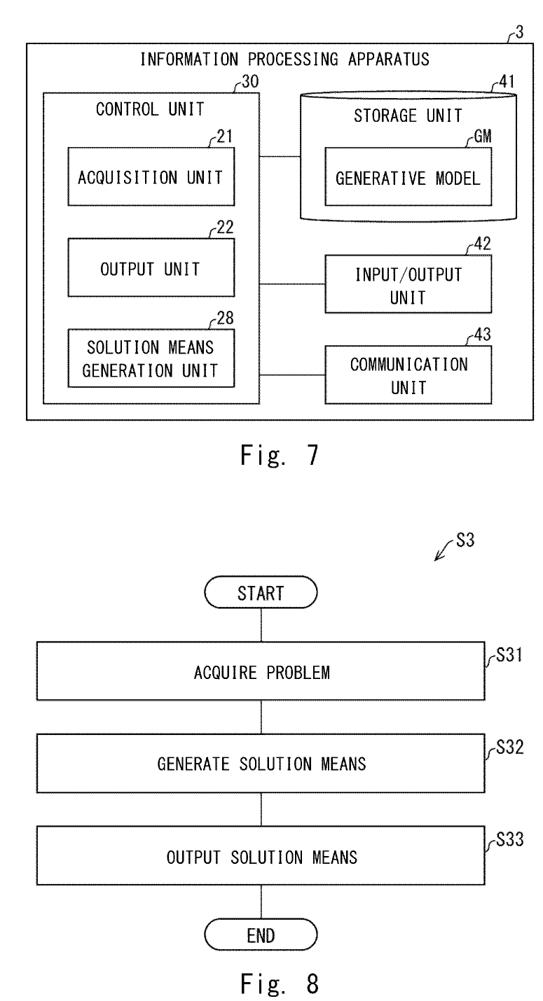

A configuration of the information processing apparatus 3 will be described with reference to FIG. 7. FIG. 7 is a block diagram illustrating the configuration of the information processing apparatus 3. As illustrated in FIG. 7, the information processing apparatus 3 includes a control unit 30, a storage unit 41, an input/output unit 42, and a communication unit 43. The storage unit 41, the input/output unit 42, and the communication unit 43 are as described above.

### Control Unit 30

The control unit 30 controls each component included in the information processing apparatus 3. As illustrated in FIG. 7, the control unit 30 includes an acquisition unit 21, an output unit 22, and a solution means generation unit 28. The acquisition unit 21, the output unit 22, and the solution means generation unit 28 respectively achieve acquisition means, output means, and solution means generation means, in the present exemplary example embodiment.

### Acquisition Unit 21

The acquisition unit 21 acquires data via the input/output unit 42 or the communication unit 43, similarly to the acquisition unit 21 in the above exemplary example embodiment. The acquisition unit 21 stores the acquired data in the storage unit 41. As an example, the acquisition unit 21 acquires a problem of the invention.

### Output Unit 22

The output unit 22 outputs data via the input/output unit 42 or the communication unit 43, similarly to the output unit 22 in the above exemplary example embodiment. As an example, the output unit 22 outputs the solution means generated by the solution means generation unit 28.

### Solution Means Generation Unit 28

The solution means generation unit 28 generates the solution means for solving the problem using a generative model GM, similarly to the solution means generation unit 28 in the above exemplary example embodiment. More specifically, the solution means generation unit 28 generates the solution means, by inputting the problem acquired by the acquisition unit 21 and a prompt for instructing to generate the solution means that solves the problem into the generative model GM. An example of the prompt is as described above.

### Example of Flow of Processing Executed by Information Processing Apparatus 3

An example of a flow of processing (information processing method S3) executed by the information processing apparatus 3 will be described with reference to FIG. 8. FIG. 8 is a flowchart illustrating an example of the flow of the information processing method S3.

### Step S31

In step S31, the acquisition unit 21 acquires the problem of the invention. The acquisition unit 21 stores the acquired problem in the storage unit 41.

### Step S32

In step S32, the solution means generation unit 28 generates the solution means, by inputting the problem acquired in step S31 and a prompt for instructing to generate the solution means for solving the problem into the generative model GM. The solution means generation unit 28 stores the generated solution means in the storage unit 41.

### Step S33

In step S33, the output unit 22 outputs the solution means generated in step S32.

### Effects of Information Processing Apparatus 3

As described above, the information processing apparatus 3 adopts a configuration including the acquisition unit 21 that acquires the problem of the invention, the solution means generation unit 28 that generates the solution means for solving the problem using the generative model GM, and the output unit 22 that outputs the solution means.

Therefore, according to the information processing apparatus 3, it is possible to cause an inventor to perform training for deriving the solution means for the virtual problem.

### Exemplary Implementation by Software

Some or all of the functions of the information processing apparatuses 1 to 3 (hereinafter, also referred to as “each of the above devices”) may be achieved by hardware such as an integrated circuit (IC chip) or may be achieved by software.

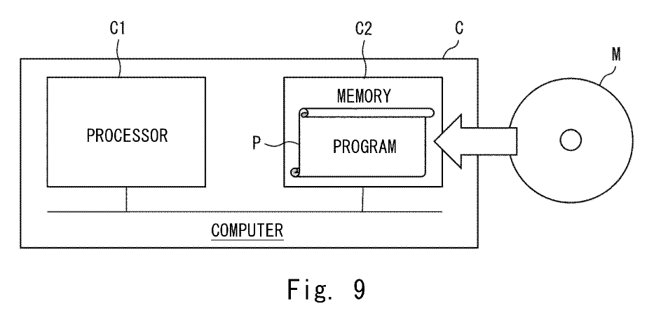

In the latter case, each of the above devices is achieved by, for example, a computer that executes commands of a program, that is software for achieving each function. FIG. 9 illustrates an example of such a computer (hereinafter, referred to as computer C). FIG. 9 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is achieved.

Available examples of the processor C1 include a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof. Available examples of the memory C2 include a flash memory, a Hard Disk Drive (HDD), a Solid State Drive (SSD), or a combination thereof.

The computer C may further include a Random Access Memory (RAM) for expanding the program P at the time of execution and temporarily storing various types of data. The computer C may further include a communication interface for exchanging data with another device. The computer C may further include an input/output interface for connecting input/output equipment such as a keyboard, a mouse, a display, or a printer.

The program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors respectively provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories respectively provided in a plurality of computers.

### Supplementary Matter A

The present disclosure includes the techniques described in the following Supplementary Notes. However, the present invention is not limited to the techniques described in the following Supplementary Notes, and various modifications can be made within the scope described in the claims.

### Supplementary Note A1

An information processing apparatus that creates a claim in a filing document using a generative model, the information processing apparatus including:

first proposal creation means for referring to an idea of an invention and creating a first proposal of the claim regarding the idea;

generation means for generating a variation idea related to the first proposal;

determination means for determining whether the variation idea is an internal addition to the first proposal or an external addition to the first proposal; and

second proposal creation means for referring to a determination result by the determination means and creating a second proposal of the claim.

### Supplementary Note A2

The information processing apparatus according to supplementary note A1, in which

in a case where it is determined that the variation idea is the internal addition to the first proposal, the second proposal creation means creates the second proposal obtained by adding a superordinate concept of the variation idea to the first proposal, and

in a case where it is determined that the variation idea is the external addition to the first proposal, the second proposal creation means creates the second proposal in which the variation idea is changed into a dependent claim and is added to the first proposal.

### Supplementary Note A3

The information processing apparatus according to supplementary note A1 or A2, further including output means for outputting the determination result by the determination means.

### Supplementary Note A4

The information processing apparatus according to supplementary note A3, further including evaluation means for evaluating feasibility and ease of infringement confirmation of the variation idea,

in which the output means outputs the variation idea and an evaluation result evaluated by the evaluation means.

### Supplementary Note A5

The information processing apparatus according to supplementary note A3, further including acquisition means for acquiring an input from a user, in which

the acquisition means acquires an input for the determination result output by the output means, and

the second proposal creation means creates the second proposal of the claim according to the input.

### Supplementary Note A6

The information processing apparatus according to supplementary note A5, in which

the second proposal creation means creates a plurality of the second proposals,

the output means outputs the plurality of second proposals, and

the acquisition means acquires an input indicating that the user has selected at least any one of the plurality of second proposals.

### Supplementary Note A7

The information processing apparatus according to supplementary note A5 or A6, in which

the generation means generates a plurality of the variation ideas,

the output means outputs the plurality of variation ideas,

the acquisition means acquires an input indicating that the user has selected at least any one of the plurality of variation ideas, and

the generation means generates a variation idea derived from the selected variation idea.

### Supplementary Note A8

The information processing apparatus according to any one of supplementary notes A5 to A7, in which in a case where the acquisition means receives an input indicating agreement with the determination result, the second proposal creation means refers to the determination result and creates the second proposal of the claim.

### Supplementary Note A9

The information processing apparatus according to any one of supplementary notes A5 to A8, in which in a case where the acquisition means receives an input regarding user’s desire with respect to the second proposal, the second proposal creation means creates the second proposal of the claim based on the user’s desire.

### Supplementary Note A10

The information processing apparatus according to any one of supplementary notes A1 to A9, in which the generation means generates a variation idea specialized in a field related to the invention.

### Supplementary Note A11

The information processing apparatus according to any one of supplementary notes A1 to A10, in which the generation means generates a variation idea based on a patent strategy.

### Supplementary Note A12

The information processing apparatus according to any one of supplementary notes A1 to A11, in which the generation means refers to information regarding a patent similar to the invention or a patent in a technical field related to the invention and generates the variation idea.

### Supplementary Note A13

The information processing apparatus according to any one of supplementary notes A1 to A12, further including figure creation means for creating a drawing regarding the second proposal.

### Supplementary Note A14

The information processing apparatus according to supplementary note A4, in which the evaluation means evaluates patentability of the second proposal.

### Supplementary Note A15

The information processing apparatus according to any one of supplementary notes A1 to A14, further including specification creation means for creating a patent specification, using the second proposal as a claim.

### Supplementary Note A16

The information processing apparatus according to any one of supplementary notes A1 to A15, further including translation means for translating the second proposal into a single or a plurality of languages.

### Supplementary Note A17

The information processing apparatus according to any one of supplementary notes A1 to A16, further including optimization means for referring to a technical term in a field of the invention and optimizing the second proposal.

### Supplementary Note A18

The information processing apparatus according to any one of supplementary notes A2 to A9, in which

the acquisition means acquires a problem of an invention, and

the information processing apparatus further including solution means generation means for generating solution means for solving the problem.

### Supplementary Matter B

The present disclosure includes the techniques described in the following Supplementary Notes. However, the present invention is not limited to the techniques described in the following Supplementary Notes, and various modifications can be made within the scope described in the claims.

### Supplementary Note B1

An information processing method for creating a claim in a filing document using a generative model, the information processing method including:

first proposal creation processing for referring to an idea of an invention and creating a first proposal of the claim regarding the idea, by at least one processor;

generation processing for generating a variation idea related to the first proposal, by the at least one processor;

determination processing for determining whether the variation idea is an internal addition to the first proposal or an external addition to the first proposal, by the at least one processor; and

second proposal creation processing for referring to a determination result by the determination processing and creating a second proposal of the claim, by the at least one processor.

### Supplementary Note B2

The information processing method according to supplementary note B1, in which

in a case where it is determined that the variation idea is the internal addition to the first proposal, in the second proposal creation processing, the at least one processor creates the second proposal obtained by adding a superordinate concept of the variation idea to the first proposal, and

in a case where it is determined that the variation idea is the external addition to the first proposal, in the second proposal creation processing, the at least one processor creates the second proposal in which the variation idea is changed into a dependent claim and is added to the first proposal.

### Supplementary Note B3

The information processing method according to supplementary note B1 or B2, further including output processing for outputting the determination result by the determination processing, by the at least one processor.

### Supplementary Note B4

The information processing method according to supplementary note B3, further including evaluation processing for evaluating feasibility and ease of infringement confirmation of the variation idea, by the at least one processor,

in which in the output processing, the at least one processor outputs the variation idea and an evaluation result evaluated by the evaluation processing.

### Supplementary Note B5

The information processing method according to supplementary note B3, further including acquisition processing for acquiring an input from a user, by the at least one processor, in which

in the acquisition processing, the at least one processor acquires an input for the determination result output in the output processing, and

in the second proposal creation processing, the at least one processor creates the second proposal of the claim according to the input.

### Supplementary Note B6

The information processing method according to supplementary note B5, in which

the second proposal creation processing creates a plurality of the second proposals,

in the output processing, the at least one processor outputs the plurality of second proposals, and

in the acquisition processing, the at least one processor acquires an input indicating that the user has selected at least any one of the plurality of second proposals.

### Supplementary Note B7

The information processing method according to supplementary note B5 or B6, in which

in the generation processing, the at least one processor generates a plurality of the variation ideas,

in the output processing, the at least one processor outputs the plurality of variation ideas,

in the acquisition processing, the at least one processor acquires an input indicating that the user has selected at least any one of the plurality of variation ideas, and

in the generation processing, the at least one processor generates a variation idea derived from the selected variation idea.

### Supplementary Note B8

The information processing method according to any one of supplementary notes B5 to B7, in which in the acquisition processing, in a case where an input indicating agreement with the determination result is received, in the second proposal creation processing, the at least one processor refers to the determination result and creates the second proposal of the claim.

### Supplementary Note B9

The information processing method according to any one of supplementary notes B5 to B8, in which in the acquisition processing, in a case where an input regarding user’s desire with respect to the second proposal is received, in the second proposal creation processing, the at least one processor creates the second proposal of the claim based on the user’s desire.

### Supplementary Note B10

The information processing method according to any one of supplementary notes B1 to B9, in which in the generation processing, the at least one processor generates a variation idea specialized in a field related to the invention.

### Supplementary Note B11

The information processing method according to any one of supplementary notes B1 to B10, in which in the generation processing, the at least one processor generates a variation idea based on a patent strategy.

### Supplementary Note B12

The information processing method according to any one of supplementary notes B1 to B11, in which in the generation processing, the at least one processor refers to information regarding a patent similar to the invention or a patent in a technical field related to the invention and generates the variation idea.

### Supplementary Note B13

The information processing method according to any one of supplementary notes B1 to B12, further including figure creation processing for creating a drawing regarding the second proposal, by the at least one processor.

### Supplementary Note B14

The information processing method according to supplementary note B4, in which in the evaluation processing, the at least one processor evaluates patentability of the second proposal.

### Supplementary Note B15

The information processing method according to any one of supplementary notes B1 to B14, further including specification creation processing for creating a patent specification, using the second proposal as a claim, by the at least one processor.

### Supplementary Note B16

The information processing method according to any one of supplementary notes B1 to B15, further including translation processing for translating the second proposal into a single or a plurality of languages, by the at least one processor.

### Supplementary Note B17

The information processing method according to any one of supplementary notes B1 to B16, further including optimization processing for referring to a technical term in a field of the invention and optimizing the second proposal, by the at least one processor.

### Supplementary Note B18

The information processing method according to any one of supplementary notes B2 to B9, in which

in the acquisition processing, the at least one processor acquires a problem of an invention, and

the information processing method further including solution processing generation processing for generating solution processing for solving the problem, by the at least one processor.

### Supplementary Matter C

The present disclosure includes the techniques described in the following Supplementary Notes. However, the present invention is not limited to the techniques described in the following Supplementary Notes, and various modifications can be made within the scope described in the claims.

### Supplementary Note C1

An information processing program that causes a computer to function as an information processing apparatus that creates a claim in a filing document using a generative model, the information processing program causes the computer to function as:

first proposal creation means for referring to an idea of an invention and creating a first proposal of the claim regarding the idea;

generation means for generating a variation idea related to the first proposal;

determination means for determining whether the variation idea is an internal addition to the first proposal or an external addition to the first proposal; and

second proposal creation means for referring to a determination result by the determination means and creating a second proposal of the claim.

### Supplementary Note C2

The information processing program according to supplementary note C1, in which

in a case where it is determined that the variation idea is the internal addition to the first proposal, the second proposal creation means creates the second proposal obtained by adding a superordinate concept of the variation idea to the first proposal, and

in a case where it is determined that the variation idea is the external addition to the first proposal, the second proposal creation means creates the second proposal in which the variation idea is changed into a dependent claim and is added to the first proposal.

### Supplementary Note C3

The information processing program according to supplementary note C1 or C2, in which the computer is caused to further function as output means for outputting the determination result by the determination means.

### Supplementary Note C4

The information processing program according to supplementary note C3, in which

the computer is caused to further function as

evaluation means for evaluating feasibility and ease of infringement confirmation of the variation idea, and

the output means outputs the variation idea and an evaluation result evaluated by the evaluation means.

### Supplementary Note C5

The information processing program according to supplementary note C3, in which

the computer is caused to further function as

acquisition means for acquiring an input from a user,

the acquisition means acquires an input for the determination result output by the output means, and

the second proposal creation means creates the second proposal of the claim according to the input.

### Supplementary Note C6

The information processing program according to supplementary note C5, in which

the second proposal creation means creates a plurality of the second proposals,

the output means outputs the plurality of second proposals, and

the acquisition means acquires an input indicating that the user has selected at least any one of the plurality of second proposals.

### Supplementary Note C7

The information processing program according to supplementary note C5 or C6, in which

the generation means generates a plurality of the variation ideas,

the output means outputs the plurality of variation ideas,

the acquisition means acquires an input indicating that the user has selected at least any one of the plurality of variation ideas, and

the generation means generates a variation idea derived from the selected variation idea.

### Supplementary Note C8

The information processing program according to any one of supplementary notes C5 to C7, in which in a case where the acquisition means receives an input indicating agreement with the determination result, the second proposal creation means refers to the determination result and creates the second proposal of the claim.

### Supplementary Note C9

The information processing program according to any one of supplementary notes C5 to C8, in which in a case where the acquisition means receives an input regarding user’s desire with respect to the second proposal, the second proposal creation means creates the second proposal of the claim based on the user’s desire.

### Supplementary Note C10

The information processing program according to any one of supplementary notes C1 to C9, in which the generation means generates a variation idea specialized in a field related to the invention.

### Supplementary Note C11

The information processing program according to any one of supplementary notes C1 to C10, in which the generation means generates a variation idea based on a patent strategy.

### Supplementary Note C12

The information processing program according to any one of supplementary notes C1 to C11, in which the generation means refers to information regarding a patent similar to the invention or a patent in a technical field related to the invention and generates the variation idea.

### Supplementary Note C13

The information processing program according to any one of supplementary notes C1 to C12, in which the computer is caused to further function as figure creation means for creating a drawing regarding the second proposal.

### Supplementary Note C14

The information processing program according to supplementary note C4, in which the evaluation means evaluates patentability of the second proposal.

### Supplementary Note C15

The information processing program according to any one of supplementary notes C1 to C14, in which the computer is caused to further function as specification creation means for creating a patent specification, using the second proposal as a claim.

### Supplementary Note C16

The information processing program according to any one of supplementary notes C1 to C15, in which the computer is caused to further function as translation means for translating the second proposal into a single or a plurality of languages.

### Supplementary Note C17

The information processing program according to any one of supplementary notes C1 to C16, in which the computer is caused to further function as optimization means for referring to a technical term in a field of the invention and optimizing the second proposal.

### Supplementary Note C18

The information processing program according to any one of supplementary notes C2 to C9, in which

the acquisition means acquires a problem of an invention, and

the computer

is caused to further function as solution means generation means for generating solution means for solving the problem.

### Supplementary Matter D

The present disclosure includes the techniques described in the following Supplementary Notes. However, the present invention is not limited to the techniques described in the following Supplementary Notes, and various modifications can be made within the scope described in the claims.

### Supplementary Note D1

An information processing apparatus for creating a claim in a filing document using a generative model, including:

at least one processor, in which

the at least one processor executes

first proposal creation processing for referring to an idea of an invention and creating a first proposal of the claim regarding the idea,

generation processing for generating a variation idea related to the first proposal,

determination processing for determining whether the variation idea is an internal addition to the first proposal or an external addition to the first proposal, and

second proposal creation processing for referring to a determination result by the determination processing and creating a second proposal of the claim.

The information processing apparatus may further include a memory. The memory may store a program for causing the at least one processor to execute each of the processing.

### Supplementary Note D2

The information processing apparatus according to supplementary note D1, in which

in a case where it is determined that the variation idea is the internal addition to the first proposal, in the second proposal creation processing, the at least one processor creates the second proposal obtained by adding a superordinate concept of the variation idea to the first proposal, and

in a case where it is determined that the variation idea is the external addition to the first proposal, in the second proposal creation processing, the at least one processor creates the second proposal in which the variation idea is changed into a dependent claim and is added to the first proposal.

### Supplementary Note D3

The information processing apparatus according to supplementary note D1 or D2, in which the at least one processor further executes output processing for outputting the determination result by the determination processing.

### Supplementary Note D4

The information processing apparatus according to supplementary note D3, in which

the at least one processor further executes

evaluation processing for evaluating feasibility and ease of infringement confirmation of the variation idea and

in the output processing, the at least one processor outputs the variation idea and an evaluation result evaluated by the evaluation processing.

### Supplementary Note D5

The information processing apparatus according to supplementary note D3, in which

the at least one processor further executes

acquisition processing for acquiring an input from a user,

in the acquisition processing, the at least one processor acquires an input for the determination result output in the output processing, and

in the second proposal creation processing, the at least one processor creates the second proposal of the claim according to the input.

### Supplementary Note D6

The information processing apparatus according to supplementary note D5, in which

in the second proposal creation processing, the at least one processor creates a plurality of the second proposals,

in the output processing, the at least one processor outputs the plurality of second proposals, and

in the acquisition processing, the at least one processor acquires an input indicating that the user has selected at least any one of the plurality of second proposals.

### Supplementary Note D7

The information processing apparatus according to supplementary note D5 or D6, in which

in the generation processing, the at least one processor generates a plurality of the variation ideas,

in the output processing, the at least one processor outputs the plurality of variation ideas,

in the acquisition processing, the at least one processor acquires an input indicating that the user has selected at least any one of the plurality of variation ideas, and

in the generation processing, the at least one processor generates a variation idea derived from the selected variation idea.

### Supplementary Note D8

The information processing apparatus according to any one of supplementary notes D5 to D7, in which in the acquisition processing, in a case where an input indicating agreement with the determination result is received, in the second proposal creation processing, the at least one processor refers to the determination result and creates the second proposal of the claim.

### Supplementary Note D9

The information processing apparatus according to any one of supplementary notes D5 to D8, in which in the acquisition processing, in a case where an input regarding user’s desire with respect to the second proposal is received, in the second proposal creation processing, the at least one processor creates the second proposal of the claim based on the user’s desire.

### Supplementary Note D10

The information processing apparatus according to any one of supplementary notes D1 to D9, in which in the generation processing, the at least one processor generates a variation idea specialized in a field related to the invention.

### Supplementary Note D11

The information processing apparatus according to any one of supplementary notes D1 to D10, in which in the generation processing, the at least one processor generates a variation idea based on a patent strategy.

### Supplementary Note D12

The information processing apparatus according to any one of supplementary notes D1 to D11, in which in the generation processing, the at least one processor refers to information regarding a patent similar to the invention or a patent in a technical field related to the invention and generates the variation idea.

### Supplementary Note D13

The information processing apparatus according to any one of supplementary notes D1 to D12, in which the at least one processor further executes figure creation processing for creating a drawing regarding the second proposal.

### Supplementary Note D14

The information processing apparatus according to supplementary note D4, in which in the evaluation processing, the at least one processor evaluates patentability of the second proposal.

### Supplementary Note D15

The information processing apparatus according to any one of supplementary notes D1 to D14, in which the at least one processor further executes specification creation processing for creating a patent specification, using the second proposal as a claim.

### Supplementary Note D16

The information processing apparatus according to any one of supplementary notes D1 to D15, in which the at least one processor further executes translation processing for translating the second proposal into a single or a plurality of languages.

### Supplementary Note D17

The information processing apparatus according to any one of supplementary notes D1 to D16, in which the at least one processor further executes optimization processing for referring to a technical term in a field of the invention and optimizing the second proposal.

### Supplementary Note D18

The information processing apparatus according to any one of supplementary notes D2 to D9, in which

in the acquisition processing, the at least one processor acquires a problem of an invention, and

the at least one processor

further executes solution processing generation processing for generating solution processing for solving the problem.

### Supplementary Matter E

The present disclosure includes the techniques described in the following Supplementary Notes. However, the present invention is not limited to the techniques described in the following Supplementary Notes, and various modifications can be made within the scope described in the claims.

### Supplementary Note E1

A non-transitory recording medium recording an information processing program that causes a computer to function as an information processing apparatus that creates a claim in a filing document using a generative model and causes the computer to execute:

first proposal creation processing for referring to an idea of an invention and creating a first proposal of the claim regarding the idea;

generation processing for generating a variation idea related to the first proposal;

determination processing for determining whether the variation idea is an internal addition to the first proposal or an external addition to the first proposal; and

second proposal creation processing for referring to a determination result by the determination processing and creating a second proposal of the claim.

1. An information processing apparatus that creates a claim in a filing document using a generative model, the information processing apparatus comprising:
at least one memory that is configured to store instructions; and
at least one processor that is configured to execute the instructions to: refer to an idea of an invention;
create a first proposal of the claim regarding the idea;
generate a variation idea related to the first proposal;
determine whether the variation idea is an internal addition to the first proposal or an external addition to the first proposal;
refer to a determination result; and
create a second proposal of the claim.

2. The information processing apparatus according to claim 1, wherein the at least one processor is configured to execute the instructions to:
in a case where it is determined that the variation idea is the internal addition to the first proposal, create the second proposal obtained by adding a superordinate concept of the variation idea to the first proposal; and
in a case where it is determined that the variation idea is the external addition to the first proposal, create the second proposal in which the variation idea is changed into a dependent claim and is added to the first proposal.

3. The information processing apparatus according to claim 1, wherein the at least one processor is configured to execute the instructions to output the determination result.

4. The information processing apparatus according to claim 3, wherein the at least one processor is configured to execute the instructions to:
evaluate feasibility and ease of infringement confirmation of the variation idea;
output the variation idea and an evaluation result.

5. The information processing apparatus according to claim 3, wherein
the at least one processor is configured to execute the instructions to: acquire, from a user, an input for the determination result; and
create the second proposal of the claim according to the input.

6. The information processing apparatus according to claim 5, wherein the at least one processor is configured to execute the instructions to:
create a plurality of the second proposals;
output the plurality of second proposals; and
acquire an input indicating that the user has selected at least any one of the plurality of second proposals.

7. The information processing apparatus according to claim 5, wherein the at least one processor is configured to execute the instructions to:
generate a plurality of the variation ideas,
output the plurality of variation ideas,
acquire an input indicating that the user has selected at least any one of the plurality of variation ideas, and
generate a variation idea derived from the selected variation idea.

8. The information processing apparatus according to claim 1, wherein the at least one processor is configured to execute the instructions to generate a variation idea specialized in a field related to the invention.

9. The information processing apparatus according to claim 5, wherein, the at least one processor is configured to execute the instructions to, in a case of receiving an input related to desire of the user, create the second proposal of the claim based on the desire of the user.

10. The information processing apparatus according to claim 1, wherein the at least one processor is configured to execute the instructions to generate a variation idea specialized in a field related to the invention.

11. The information processing apparatus according to claim 1, wherein the at least one processor is configured to execute the instructions to generate a variation idea based on a patent strategy.

12. The information processing apparatus according to claim 1, wherein the at least one processor is configured to execute the instructions to:
refer to information regarding a patent similar to the invention or a patent in a technical field related to the invention; and
generate the variation idea.

13. The information processing apparatus according to claim 1, wherein the at least one processor is configured to execute the instructions to create a drawing related to the second proposal.

14. The information processing apparatus according to claim 4, wherein the at least one processor is configured to execute the instructions to evaluate patentability of the second proposal.

15. The information processing apparatus according to claim 1, wherein the at least one processor is configured to execute the instructions to create a patent specification, using the second proposal as a claim.

16. The information processing apparatus according to claim 1, wherein the at least one processor is configured to execute the instructions to translate the second proposal into a single or a plurality of languages.

17. The information processing apparatus according to claim 1, wherein the at least one processor is configured to execute the instructions to:
refer to a technical term in a field of the invention; and
optimize the second proposal.

18. The information processing apparatus according to claim 2, wherein the at least one processor is configured to execute the instructions to:
acquire a problem of the invention; and
generate solution means for solving the problem.

19. An information processing method for creating a claim in a filing document using a generative model, the information processing method comprising:
referring to an idea of an invention;
creating a first proposal of the claim regarding the idea;
generating a variation idea related to the first proposal;
determining whether the variation idea is an internal addition to the first proposal or an external addition to the first proposal;
referring to a determination result; and
creating a second proposal of the claim.

20. A non-transitory computer-readable medium storing an information processing program that causes a computer to function as an information processing apparatus that creates a claim in a filing document using a generative model, the information processing program causes the computer to execute processing for:
referring to an idea of an invention;
creating a first proposal of the claim regarding the idea;
generating a variation idea related to the first proposal;
determining whether the variation idea is an internal addition to the first proposal or an external addition to the first proposal; and
referring to a determination result; and
creating a second proposal of the claim.
